(19) United States
(12) Patent Application Publication
(10) Pub. No.: US 2013/0346452 A1
(43) Pub. Date: Dec. 26, 2013

(54) Transmedia Inventory Management Systems and Methods

(71) Applicants: Brian Elan Lee, Los Angeles, CA (US); Michael Sean Stewart, Santa Monica, CA (US); James Stewartson, Manhattan Beach, CA (US)

(72) Inventors: Brian Elan Lee, Los Angeles, CA (US); Michael Sean Stewart, Santa Monica, CA (US); James Stewartson, Manhattan Beach, CA (US)

(73) Assignee: FOURTH WALL STUDIOS, INC., Culver City, CA (US)

(21) Appl. No.: 13/614,882

(22) Filed: Sep. 13, 2012

Related U.S. Application Data
(60) Provisional application No. 61/534,227, filed on Sep. 13, 2011.

(51) Int. Cl. G06F 17/30

(52) U.S. Cl. CPC G06F 17/30557
USPC 707/805

(57) ABSTRACT

Inventory management systems and methods are described in which a user can manage inventory instances across multiple, independent stories. A transmedia inventory management system can include an inventory database to store inventory objects and a story database to store a plurality of independent story templates. A story engine can generate multiple, independent stories from the story templates. An inventory management engine can be used to manage instances of at least some of the inventory objects across the independent stories. A user can interact with at least some of the instances using first and second distinct user interfaces, respectively.

This application claims the benefit of priority to U.S. provisional application having Ser. No. 61/534,227 filed on Sep. 13, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is systems and methods for inventory management across different media.

### BACKGROUND

Various systems and methods of inventory management are known in the art, including systems for game inventory management described in U.S. Pat. No. 7,713,116 to Keam, et al. and WIPO pat. publ. no. 2007/047569 to Luchene, et al. (publ. Apr. 2007). However, it has yet to be appreciated that users' inventories can be managed across different and distinct media.

Thus, there is still a need for inventory management systems that manage inventory across different media.

### SUMMARY OF THE INVENTION

The inventive subject matter provides apparatus, systems and methods in which one can manage inventories across different media. In one aspect, a transmedia inventory management system can include an inventory database configured to store a plurality of inventory objects, and a story database configured to store a plurality of independent story templates. A story engine can be coupled to the story database and configured to generate at least two independent stories from the plurality of story templates. As used herein, the term “independent stories” means that each story has a storyline that is different to the other story, which could be from the same or different developers, for example. Preferably, the stories are unrelated to one another, in contrast to chapters in a book, a series of books or movies, or quests in a game.

It is contemplated that the independent stories could be generated from the same or different story templates. For example, a single story template could be used to generate multiple, independent stories by utilizing different data inputs.

Contemplated systems preferably also include an inventory management engine coupled to the inventory database, and configured to manage instances of at least some of the inventory objects across the independent first and second stories. In this manner, it is contemplated that a user could interact with some or all of the inventory instances associated with the user in the first and second stories, despite the independent nature of the stories. Thus, the system can thereby permit a user to access his or her inventory across a plurality of unrelated stories created by the same or different companies or developers. Just as a person in the real world has possessions that can be taken from one story (e.g., work) to another story (e.g., home), and some of the possessions will be useful in more than one story, and their usefulness and/or functionality can vary depending on the story, the inventory management system similarly allows inventory instances to be accessed and stored independently of a particular story with which a user is interacting. The inventory management system also advantageously creates a framework for developers to manage inventories, and therefore reduces the work required to create new stories or games.

The inventory management system could further be configured to associate instances of at least some of the inventory objects with a user as a function of the user's interaction with at least one of the first and second stories. Thus, one or more inventory instances may be associated with a user (a) passively as the user achieves milestones or otherwise progresses through a story, (b) as a reward for some action or inaction by the user, (c) upon the user reaching one or more trigger points, and/or (d) by combining existing inventory objects. At least some of the inventory instances could then be accessed by the user within the first and second stories, where the user may utilize, sell, trade, or destroy the instances to unlock additional content, create new inventory instances, barter for different inventory instances, and so forth.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of one embodiment of a transmedia inventory management system.

FIG. 2 is a diagram of inventory object 200 comprising a plurality of inventory items.

FIG. 3 is a flowchart of one embodiment of a story.

### DETAILED DESCRIPTION

It should be noted that while the following description is drawn to a computer/server based inventory management system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

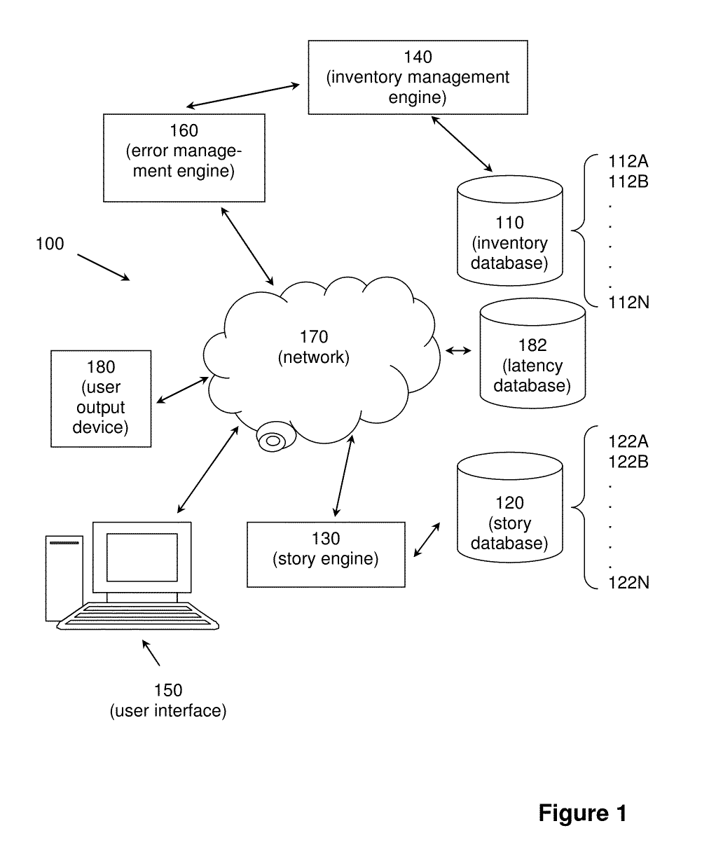

In FIG. 1, a transmedia inventory management system 100 is shown having an inventory database 110 configured to store a first plurality of inventory objects 112A-112N. System 100 preferably also includes a story server 120 configured to store a plurality of independent story templates 122A-122N. A story engine 130 can be coupled to the story server 120 and configured to generate first and second independent stories from one or more of the story templates 122A-122N. In some contemplated embodiments, the stories could be generated using various data associated with the user. Such data could include, for example, user location, date, time, local weather, local geography, local establishments, or other real-world data, or user difficulty, user experience, user interface type, user interface capability, or other user characteristics.

The story engine 130 can be further configured to generate additional stories from at least one of the story templates 122A-122N that are each (i) independent from the first and second stories and (ii) includes at least one of the inventory instances associated with the first and second stories.

System 100 can further include an inventory management engine 140 coupled to the inventory database 110 that is capable of managing instances of at least some of the first plurality of inventory objects 112A-112N across the first and second independent stories. In this manner, a user may interact with one or more of the instances associated with the user in either or both of the first and second independent stories.

Each of the inventory instances associated with a user can be stored in the inventory database 110 or other suitable location. Inventory instances could be virtually anything including, for example, audio clips, video clips, images, and links/bookmarks. Although shown directly coupled with the inventory database 110, it is contemplated that the inventory management engine 140 might access the inventory database 110 over one or more networks 170. In this manner, the inventory database 110 can be stored distally from the inventory management engine 140.

In some contemplated embodiments, system 100 can further include a user interface 150 configured to allow a user to interact with and/or manage one or more of the inventory instances associated with the user and one or both of the first and second stories, and preferably while the user is interacting with the first or second story. Thus, for example, using the user interface 150, the user might modify attributes of an inventory instance, trade an inventory instance with another user, combine one inventory instance with another inventory instance to create a new inventory instance, upgrade or otherwise enhance an existing inventory instance, downgrade or other diminish an inventory instance, or use an inventory instance to unlock content, enhance a story or user characteristics, and so forth. Any such additions, deletions, or other modifications to the user's inventory instances could then be propagated to other stories with which the instances are associated using the inventory management engine 140 or other suitable engine. It is contemplated that such changes could automatically be pushed to the associated stories to allow for approximately real-time updates to the stories. This advantageously ensures that changes to the inventory instances will be propagated across the independent stories, such that when a user interacts with a specific story, any modifications to the user's inventory will be incorporated into that and other stories as desired by the user, developer, etc.

Alternatively or additionally, modifications to the inventory instances can be stored in the inventory database 110 or other location, such that the modified inventory instances can be accessed by the first and second stories, or other stories associated with the user. The changes can thereby be read and incorporated into the associated stories.

The user interface 150 could be further configured to allow the user to interact with the user's inventory instances outside of the first and second stories (e.g., between interactions with the stories). Such interactions might include, for example, trading one or more inventory instances, purchasing new inventory instances, or combining two or more inventory instances to create a new inventory instance. It is contemplated that new inventory instances might then be used by the user within or outside of a story to unlock a new chapter in a story, or access a new story altogether.

The story engine 130 can be further configured to present the first story to the user via the user interface 150. In some cases, the user could have more than one user interface associated with the user, and the story engine 130 could present different aspects of the first story to the user via the different user interfaces. In especially preferred embodiments, one user interface might be used for some portions of the story, while another user interface might be used for other portions of the story, and in some cases, the use of user interfaces might overlap as the user interacts with the story. Thus, for example, a user might use a laptop computer to interact with the first story, and during a portion of the first story, the user might utilize a mobile phone or other user interface to further interact with the first story either simultaneously with or separately from the laptop computer. Other contemplated user interfaces include, for example, video game systems, books, e-readers, tablet PCs, netbooks, magazines, newspapers, songs, videos, kiosks, GPS units, Mp3 or other music players, televisions, or digital video recorders. A further discussion of synchronizing streams of a story to multiple user interfaces can be found in co-pending U.S. utility application having Ser. No. 13/414192 filed on Mar. 7, 2012.

In an alternative embodiment, two or more users might interact with the first story simultaneously using first and second user interfaces associated with the user(s). Thus, for example, one person might utilize a laptop computer and another person might utilize a mobile telephone to interact with the same story. Similar to a multi-player game, the two people could simultaneously interact with the story such as to accomplish an overall objective. Because of the ubiquitous nature of mobile computing, the people could voluntarily be or required to be in different locations while interacting with the first story in order to accomplish an objective of the story.

As a user interacts with at least one of the first and second stories, one or more inventory instances can be generated and/or associated with the user using the inventory management engine 140 or other suitable engine. These newly associated inventory instances can then be accessible by the user within the story, and preferably outside of that specific story using the management interface 150 or other suitable interface. For example, a user might use one or more of the new inventory instances to progress within the story or otherwise access additional content.

The interactions could include passive or active interactions depending upon the context of the story. Inventory items can be collected passively as the user progresses through a story. However, it is also contemplated that certain events could trigger a new inventory instance, which can be added to or otherwise associated with the user's inventory. For example, a character might throw something against a wall triggering an inventory instance representing anger to appear in the user's inventory, or an inventory instance might be audio/video/still images captured from the story, or the new instance could result from the user reaching a new location in the story. Inventory instances can be actively collected by the user completing one or more quests within or outside of a story including entering a code, completing a task, taking a survey, or submitting a picture, for example.

In some aspects, it is contemplated that one or more of the inventory instances can be associated with real-world items. As used herein, the term “real-world item” means an item existing in the real world, as opposed to a fictional (virtual) item. Exemplary real-world items can include, for example, coupons, directions, telephone numbers, email addresses, locations, music, movies, photographs, barcodes, QR codes, or other digital collections of information, URLs, event tickets, and cell phones. Thus, for example, an inventory instance comprising a picture of a map could be associated with a real-world printout of a map representing a real-world location.

It is further contemplated that at least one of the inventory instances can comprise or be associated with a sponsored item, which may include, for example, (a) virtual items such as a branded inventory instances (e.g., a item of clothing for a user's character) or (b) real-world items such as a coupon or directions to a coffee shop or other business possibly as a reward to the user for completing one or more tasks, or part of the story where the user must visit that particular business to complete a task, unlock an objective, or otherwise continue with the story. For example, the inventory management engine 140 might generate an inventory instance either passively or actively in response to an action by the user, where the instance is associated with directions to a particular business located near the user's location. The inventory management engine 140 could then send a request to a printer or other user output device to print directions to the business from the user's location. The user can then use these directions to reach the business and continue with the story.

The specific real-world or sponsored item associated with a user could vary depending upon the user's real-world location, as well as the available user output devices. Thus, for example, a user in California could receive directions to a different business than a user in Kansas. In addition, the specific item could vary depending upon the user's specific locale, such that a user in one city, or a geographic area of a city, could have a different associated business from a user in another city, or another geographic area of the same city. Alternatively, it may be desirable for various users to have the same business associated with inventory instances of the various users, such as when the business is paying a premium for the increased traffic, or where in-person interactions of the various users are required or desired. In a similar fashion, the specific real-world or sponsored item associated with the instance could vary depending upon the time of day or the calendar date when the user interacts with the story.

It is further contemplated that a user might also pay to obtain an inventory instance, and may pay more for a sponsored or limited inventory instance because of an intrinsic value to the user.

Although systems for mapping points in a virtual world to real-world locations are generally known in the art (e.g., U.S. pat. publ. no. 2008/0146338 to Bernard et al. (publ. June. 2008)), such systems fail to contemplate mapping inventory items to real-world items, and managing such inventory. Such systems also fail to contemplate monetizing one or more stories by mapping real-world items and locations to virtual inventory instances of a user. For example, a specific business could partner with a developer such that users in a certain geographical region would be required to visit the business in order to continue with a story. As part of the story, users might receive directions or a coupon to that business and/or the business may possess a code or other real-world item necessary for the users to progress in the story. In this manner, the business could thereby increase its foot traffic as users visit the business to complete an objective, collect a real-world item, use a real-world item associated with an inventory instance, and so forth. As another example, one or more users could receive an inventory instance associated with a coupon that could be printed or shown on a cell phone or other mobile device at a business. After the user redeems the coupon, a signal can be sent to the inventory management engine, story engine, or other component of the system 100, as appropriate, and the user might then receive one or more additional inventory instances, or unlock a chapter or objective in a story.

In still other contemplated embodiments, an inventory instance can be associated with a concert or other event ticket. Regardless of such association, a user could utilize the user interface 150 with the ticket to unlock a story, an objective or chapter in a story, or premium content. For example, a user might take a picture of the ticket or a barcode, QR code, or other information on the ticket and submit that to a server using a cell phone or other user interface. Alternatively, the user might simply navigate to a website using the user interface 150 and enter an access code or other information, or simply send a text message to a server with a code or other information. From this interaction, information could then be provided to the user to begin a story or continue with an existing story.

Although it is known to utilize augmented reality to enhance a sporting event (e.g., U.S. Pat. No. 7,796,155 and WIPO publ. no. 2011/005318 to Vertegaal, et al. (publ. Jan. 2011)), such references fail to contemplate associating a game or other story with an event or inventory. As discussed above, the story could be unlocked with the user's ticket or related information, geolocation information of the user, or other information, or could be sold to the user as an upsell online, at a ticket booth, or another location at the event. The story could include video, audio, or images from the event location that the user could pan, tilt, or otherwise move to interact with the story. The story could also include real-time information from the event to further immerse the user in the story. For example, the story might require a user to complete one or more tasks while at the event in order to unlock additional chapters in the story or receive a sponsored inventory instance or premium content such as an unreleased song or a movie trailer.

In another aspect, the story engine 130 can be further configured to receive a confirmation signal indicating that the user has utilized one or more real-world or sponsored items or arrived at a specific location. Upon receiving such signal could allow the user to advance in at least one of the first and second stories (e.g., unlock a new chapter), or present a new story to the user. After use of the real-world object, it is contemplated that the instance associated with such object could be removed from the user's inventory.

In still further embodiments, the story engine 130 can be coupled with the user interface 150 and a user output device 180 distinct from the user interface, both of which are associated with the user. Although the user output device 180 is shown coupled to the story engine 130 via network 170, it is alternatively contemplated that the user output device 180 could be coupled to the story engine 130 via a computing device that includes the user interface 150, for example. Thus, for example, a user interface might be a mobile telephone, a laptop, a desktop computer, or other computing device. Exemplary user output devices could include, for example, digital or traditional printers, email clients, land-line, cellular, or VOIP-based telephones, televisions and related components, a GPS or other navigation unit, MP3 or other media players and desktop computers, laptops, netbooks, tablet PCs, and other computing devices.

The story engine 130 can be further configured to send a command to one or more user output devices to generate or display a real-world object while a user interacts with at least one of the first and second stories, and more preferably upon the occurrence of a triggering event or within a defined period prior to or after the event's occurrence, or prior to, during, or after a user's interaction with a specific portion of the story. In one example, the story engine 130 could schedule a print job with the user's printer to generate a printout while the user interacts with the story. The printout may be a newspaper clipping, a photo, directions, a map, a coupon, or other information pertinent to the user's interactions with the story.

The story engine 130 or other suitable device could be further configured to measure a latency of the user output device 180 associated with the user, and then generate a story or modify a existing story structure for the user that accounts for the measured latency. This can be especially important where timing of the real-world object's creation is critical to the user's immersion within the story, as different user output devices will likely have different latencies. The modified story structure can then be provided to the user interface such that the user can interact with the story. By accounting for any latency in the associated user output device, the user can be further immersed within the story because such latencies can be seamlessly accounted for without interrupting the user's experience.

As an example, a story could have a character that instructs the user to pick up a phone call, and the user's phone in the real-world can receive a call. By measuring latency of the telephone or other user output device early on and preferably before the user begins interaction with the story, the story can ensure that the phone call is synchronized with the story. Otherwise, latency in receiving the phone call could detract from the user's experience.

System 100 may further include a latency database 182 configured to store a list of user output devices associated with each user, as well as information concerning the measured latencies of each user output device. The story engine 130 could then access the stored latency information when generating a story for the user to thereby synchronize any output of the user output device with the story. It is contemplated that the story engine 130 or other suitable device could utilize one or more routines to periodically test for latencies of associated user output devices, and updated the stories associated with the user as necessary to account for any changes in the measured latencies.

In some contemplated embodiments, the story engine 130 or other suitable device can be further configured to detect one or more user output devices of the user using one or more routines. In this manner, the available user output device(s) can automatically be detected, which thereby reduces setup time for the user. It is further contemplated that the user could be given the option to select the specific user output devices that can be accessed by the story.

Alternatively, a user might be instructed to utilize a user output device 180 to continue with the story. For example, the user might be presented with a phone number to call or text, a URL of a website to visit, an e-mail address to message, or a specific location to visit (e.g., geocaching).

In other contemplated embodiments, one or more user output devices unassociated with the user could be utilized by the story engine 130 or other device. For example, a clue, a piece in a scavenger hunt, a picture, a fractal barcode or other information could be printed to a third party establishment that a user must visit to retrieve the information. In the case of a scavenger hunt or fractal barcodes, the user might be required to visit multiple locations in order to collect all of the pieces/clues. Alternatively, the user might reveal a portion or additional detail of the barcode for each task that is completed. It is also contemplated that the barcode could be varied as tasks are completed, such that the information contained in the barcode can change over time. Similar to the above discussion, the specific locations could be based upon third-party payments to a developer to thereby monetize the game.

It is further contemplated that the system 100 could include an error management engine 160 configured to modify one or more stories in response to a received error from the story engine 130 or other source. After receiving an error, the story engine 130 could then present the modified story to the user via the user interface 150, possibly while the user is interacting with the story. For example, the error management engine 160 may receive a signal that a printer is not detected, out of paper, or otherwise unavailable, and modify the story in real-time to select a different user output device (e.g., an email client) or bypass that portion of the story, as appropriate. In another example, the error management engine 160 may receive a signal that a phone call to a user's real-world land-line was not answered or the phone line was busy, and modify the story in real-time to retry the call or call a different number.

Alternatively, it is contemplated that each of the stories could be stored locally with respect to the user interface 150, and include various alternative scenarios to account for potential errors that might be received. Because it is unlikely that every received error can be accounted for, each of the stories could include alternative modifications to handle the most likely errors either based upon past interactions with stories from a specific story template, or based upon a programmed selection of errors that a developer inputs, for example.

In one aspect, system 100 can further include a development interface coupled with the story engine 130, and configured to permit a developer to create or modify a story template. Using the development interface, a developer could manage events in the story template as well as triggers concerning when, how, and what inventory instances become associated to a user interacting with the story. Contemplated events include interactions between characters in a story, triggering events for inventory, external events such as placing a phone call to a user or receiving a signal that user has reached a real-world location.

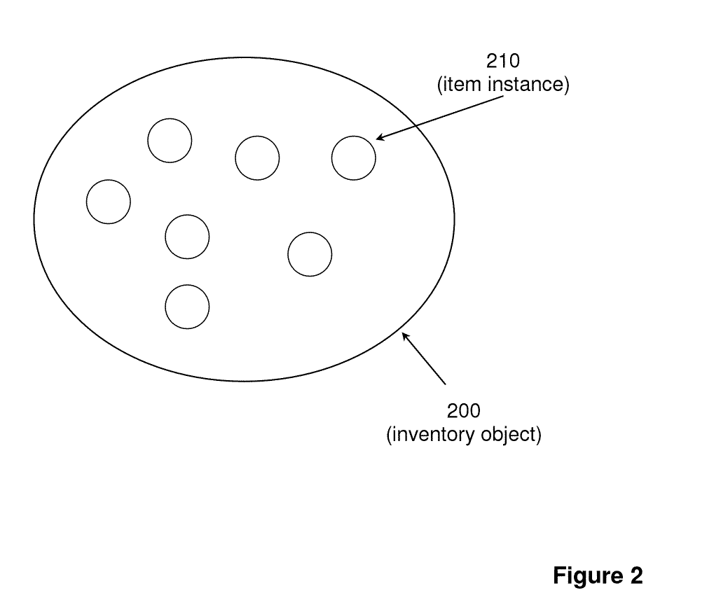

An exemplary embodiment of an inventory object 200 is shown in FIG. 2, which comprises a plurality of inventory items 210.

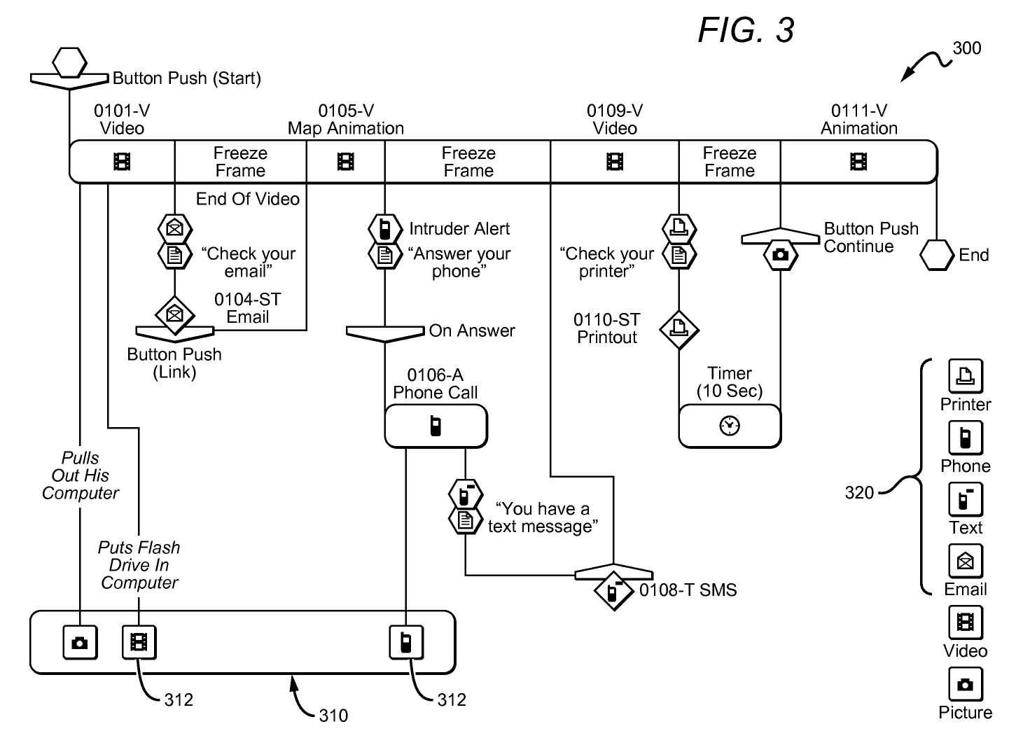

FIG. 3 illustrates a flowchart of one embodiment of a story 300. An inventory object 310 can be associated with the story, and configured to story inventory items 312. As shown in FIG. 3, the inventory items 312 can be collected by a user, as the user interacts with the story 300. For example, the user could receive a video after watching a video in the story 300. As another example, the user could receive a recording of a phone call the user had in the story.

The story 300 can interact with a story management engine or other suitable engine to interact with one or more user output devices 320. For example, the story management engine could cause a cell phone of the user to be dialed at a defined point in the story such that the user must answer the cell phone to continue with the story. In a similar manner, an email can be sent to the user's email account, or a printout can be scheduled with the user's printer at defined points in the story to further immerse the user in the story.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A transmedia inventory management system, comprising:
an inventory database configured to store a first plurality of inventory objects;
a story database configured to store a plurality of independent story templates;
a story engine coupled to the story database, and configured to generate first and second independent stories from the story templates;
an inventory management engine coupled to the inventory database, and configured to manage instances of at least some of the first plurality of inventory objects across the first and second stories; and
first and second distinct user interfaces configured to allow the user to interact with at least some of the instances in the first and second stories, respectively.

2. The system of claim 1, wherein the story engine is further configured to generate a third story from at least one of the story templates that is independent from each of the first and second stories and includes at least some of the instances.

3. The system of claim 1, further comprising an inventory interface configured to allow the user to interact with the instances within the first and second stories.

4. The system of claim 1, further comprising an inventory interface configured to allow the user to interact with the instances outside of the first and second stories.

5. The system of claim 4, wherein the inventory interface is further configured to allow the user to transfer at least one of the instances to a second user distinct from the user.

6. The system of claim 5, further comprising third and fourth independent stories associated with the second user, and wherein the inventory management engine is further configured to manage the transferred at least one instance across the third and fourth stories in a manner that allows the second user to interact with the transferred at least one instance in both the third and fourth stories.

7. The system of claim 1, further comprising a management interface configured to allow for editing of the inventory objects.

8. The system of claim 7, wherein the inventory management engine is further configured to propagate edits of the inventory objects to the instances.

9. The system of claim 1, wherein at least one of the instances is associated with a real-world item.

10. The system of claim 9, wherein the real-world item comprises at least one of a coupon, a map, a telephone number, an email address, and a location photo.

11. The system of claim 9, wherein the inventory management engine is further configured to associate at least some of the instances with the user as a function of an interaction of the user with at least one of the first and second stories.

12. The system of claim 11, wherein the inventory management engine is further configured to associate the real-world item with the user based upon at least one of a real-world geographical location and a real-world time of day of the user.

13. The system of claim 11, wherein the story engine is configured to receive a confirmation signal indicating that the user has utilized the real-world item, and then send a signal to the story engine to present the second story to the user.

14. The system of claim 11, wherein at least one of the associated instances comprises the real-world item.

15. The system of claim 1, wherein the story engine is configured to present the first story to the user via the user interface.

16. The system of claim 1, wherein at least one of the inventory instances comprises a sponsored item.

17. The system of claim 1, wherein the first story is related to an entertainment event, and wherein at least one of the instances is associated with the entertainment event, and wherein the story engine is further configured to present the first story to the first user interface as a function of an interaction of the user with the entertainment event.

18. The system of claim 17, wherein the entertainment event comprises a sporting event, a concert, a movie, a grand opening, a sale, or a fair.

19. The system of claim 17, wherein the first story is presented to the first user interface upon occurrence of a triggering event.

20. The system of claim 19, wherein the triggering event comprises at least one of (a) a purchase at the entertainment event, (b) the user reaching a defined location, and (c) a submission of a code by the user.

21. The system of claim 17, wherein the first story comprises at least one of a video, audio, and a still image from the entertainment event.

22. The system of claim 21, wherein the first user interface is further configured to permit the user to manipulate the at least one of the video, audio, and the still image.

23. The system of claim 1, wherein the story engine is further configured to associate at least one of the inventory instances with the user as a function of the interaction of the user at the entertainment event.

24. The system of claim 23, wherein the associated inventory item comprises a sponsored item.
